(19) United States
(12) Patent Application Publication
(10) Pub. No.: US 2008/0308752 A1
(43) Pub. Date: Dec. 18, 2008

(54) UV TRANS-ILLUMINATOR

(75) Inventor: Hyun-Chul Park, Wonju-Shi (KR)

Correspondence Address: HOFFMANN & BARON, LLP, 6900 JERICHO TURNPIKE, SYOSSET, NY, 11791, US

(73) Assignee: C-to-C Co., Ltd., Wonju-Shi (KR)

(21) Appl. No.: 11/869,820

(22) Filed: Oct. 10, 2007

(30) Foreign Application Priority Data
Jun. 14, 2007 (KR) 10-2007-0058314

(51) Int. Cl. G02B 5/00; G06K 7/10

(52) U.S. Cl. 250/504 R; 359/350

(57) ABSTRACT

A UV (Ultra Violet) trans-illuminator includes a UV irradiating unit composed of a plurality of CCFLs (Cold Cathode Fluorescent Lamps) or EEFLs (External Electrode Fluorescent Lamps) arranged at intervals of 1.0 cm to 3.0 cm and having a diameter of 3 mm to 8 mm so as to irradiate UV rays from an upper surface thereof, and a light dispersing unit disposed at a distance of 1 cm to 7 cm from the upper surface of the UV irradiating unit and dispersing the UV rays irradiated from the UV irradiating unit. This UV trans-illuminator has a slim design, excellent uniformity and small elapsed time change.

### BACKGROUND OF THE INVENTION

1. Field of the Invention

The present invention relates to a UV (Ultra Violet) trans-illuminator, and more particularly to a UV trans-illuminator that irradiates UV rays for the analysis of genes such as DNA or RNA nucleic acids.

2. Description of the Related Art

To check a nucleic acid, an agarose gel or an acrylic amide gel is prepared, and then the agarose gel is hardened such that an agarose well is formed it one end. The agarose gel is generally a mini gel with a size of about 10 cm×10 cm, and the agarose well has a concave shape. Subsequently, the agarose gel is moved to a horizontal or vertical electrophoresis unit, and then a nucleic acid is divided into each agarose well. Then, an electric current is applied from a (−) electrode to a (+) electrode for a predetermined time (about 30 to 40 minutes), and then the agarose gel is kept in a dye solution containing EtBr (Ethidium Bromide) for about 15 minutes and put into a flowing water a short while for decolorizing. After that, the nucleic acid is placed on a UV trans-illuminator, and then a nucleic acid band is observed while turning on a UV lamp with a common UV-B wavelength range, namely 290 nm to 320 nm.

The UV trans-illuminator is used for checking a nucleic acid band after the electrophoresis of the nucleic acid is completed. Here, a glass plate having a special filter that allows only wavelengths in the UV range to pass is installed above the UV lamp. Thus, while the nucleic acid band is moving by means of the electrophoresis of the agarose gel, EtBr (Ethidium Bromide) is emitted in a fluorescent color by the irradiated UV such that it may be observed using the naked eyes.

FIG. 1 shows a conventional UV trans-illuminator. Referring to FIG. 1, the conventional UV trans-illuminator 1 employs a UV fluorescent lamp 10 and a shade 12 that are relatively great, similarly to a fluorescent lamp used in a house. For example, a UV fluorescent lamp with a diameter of 15 mm to 16 mm or a UV fluorescent lamp with a diameter of 25 mm is used.

However, such a conventional UV trans-illuminator 1 cannot uniformly disperse the emitted UV rays, so certain figures corresponding to an arrangement pattern of fluorescent lamps are observed when the nucleic band emitting a fluorescent color light is viewed by the naked eyes. Further, the conventional UV trans-illuminator uses a polymer filter containing a natural coloring matter and thus allows only UV rays to pass through it. But, this filter shows seriously deteriorated performance in several years due to the elapsed time change caused by UV rays.

### SUMMARY OF THE INVENTION

The present invention is designed to solve the problems of the prior art, and therefore it is an object of the present invention to provide a UV trans-illuminator with excellent uniformity and small elapsed time change.

In order to accomplish the above object, the present invention provides a UV trans-illuminator, which includes a UV irradiating unit composed of a plurality of CCFLs (Cold Cathode Fluorescent Lamps) or EEFLs (External Electrode Fluorescent Lamps) arranged at intervals of 1.0 cm to 3.0 cm and having a diameter of 3 mm to 8 mm so as to irradiate UV rays from an upper surface thereof; and a light dispersing unit disposed at a distance of 1 cm to 7 cm from the upper surface of the UV irradiating unit and dispersing the UV rays irradiated from the UV irradiating unit.

Preferably, the light dispersing unit is disposed at a distance of 1 cm to 7 cm from the upper surface of the UV irradiating unit and composed of a predetermined transparent light transmitting member that allows passage of only a specific wavelength range among the UV rays irradiated from the UV irradiating unit, and a bottom of the transparent light transmitting member has a dispersion surface with a predetermined roughness by bead blasting or sand blasting.

### BRIEF DESCRIPTION OF THE DRAWINGS

Other objects and aspects of the present invention will become apparent from the following description of embodiments with reference to the accompanying drawing in which:

FIG. 1 is a schematic view showing a conventional UV trans-illuminator;

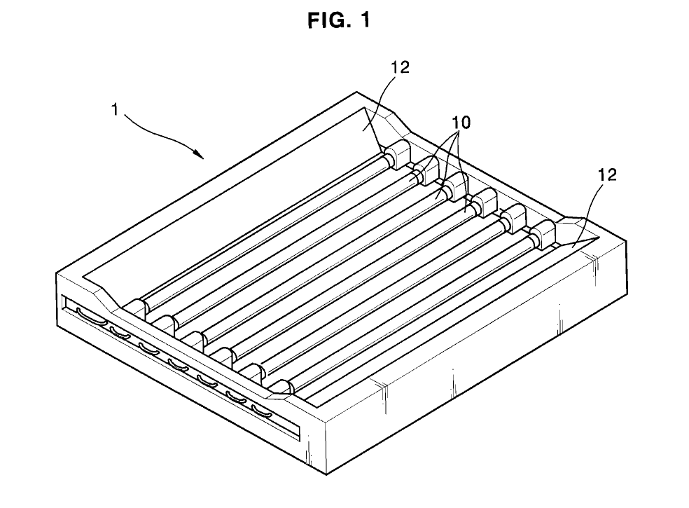

FIG. 2 is an exploded perspective view showing a UV trans-illuminator according to a preferred embodiment of the present invention;

FIG. 3 is a diagram illustrating a process of forming a light dispersing unit; and

FIG. 4 is a perspective view showing a UV lamp employed in the present invention.

### DESCRIPTION OF THE PREFERRED EMBODIMENT

Hereinafter, preferred embodiments of the present invention will be described in detail with reference to the accompanying drawings.

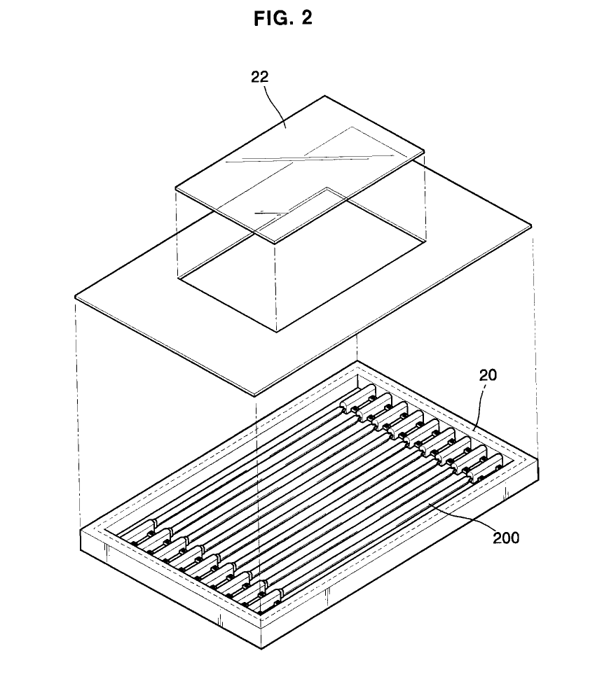

FIG. 2 is an exploded perspective view showing a UV trans-illuminator according to a preferred embodiment of the present invention. Referring to FIG. 2, the UV trans-illuminator 2 according to the preferred embodiment of the present invention includes a UV irradiating unit 20 composed of a plurality of CCFLs (Cold Cathode Fluorescent Lamps) 200 or EEFLs (External Electrode Fluorescent Lamps) 200 arranged at intervals of 1.0 cm to 3.0 cm and having a diameter of 3 mm to 8 mm so as to irradiate UV rays from an upper surface thereof; and a light dispersing unit 22 disposed at a distance of 1 cm to 7 cm from the upper surface of the UV irradiating unit 20 and dispersing the UV rays irradiated from the UV irradiating unit 20.

Here, if the UV lamps 200 are arranged at intervals less than 1.0 cm, it is difficult to mount the UV lamps in physical aspect in consideration of diameters of the lamps. If the UV lamps 200 are arranged at intervals more than 3.0 cm, the light emitted through the light dispersing unit 22 are not uniformly dispersed but show low uniformity such that certain figures are observed. Thus, the UV lamps 200 should be arranged at intervals of 1.0 cm to 3.0 cm between them. However, in case the UV lamps 200 are arranged at intervals in the range of 1.0 cm to 1.5 cm, a high voltage electric discharge may occur among the UV lamps, so it is more preferred to add an isolation partition made of electric insulator such as plastic.

In addition, the UV lamps 200, namely the CCFLs or EEFLs, has a slim design. Thus, if the UV lamps 200 are disposed at a distance of less than 1 cm from the light dispersing unit 22, a figure is observed on the UV lamps due to deficient dispersion. Also, if the UV lamps 200 are disposed at a distance of more than 7 cm from the light dispersing unit 22, UV rays emitted from the UV lamps have insufficient intensity. Thus, the light dispersing unit 22 is disposed at a distance of 1 cm to 7 cm from the upper surface of the UV lamps 200.

Also, it should be noted that the light dispersing unit 22 of the UV trans-illuminator according to the present invention has a dispersion surface 220 in a bottom of the light dispersing unit 22, the dispersion surface 220 having a predetermined roughness by bead blasting or sand blasting.

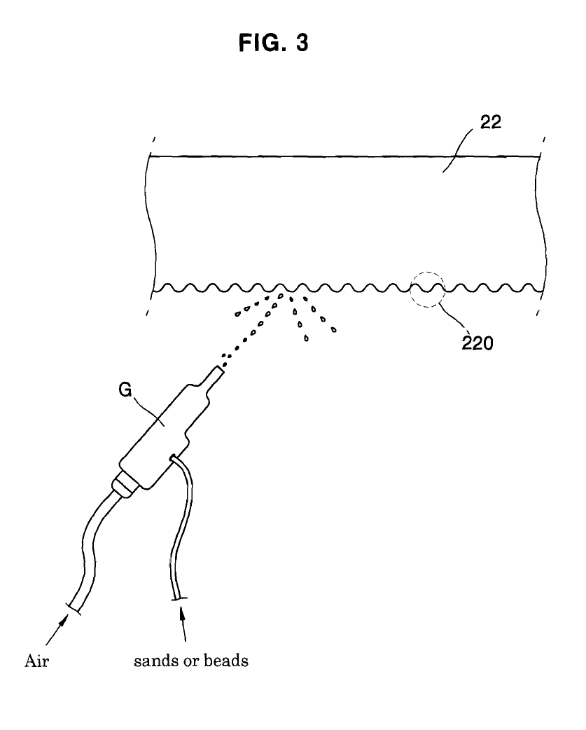

FIG. 3 is a diagram illustrating a process of forming the dispersion surface 220 of the light dispersing unit 22. Referring to FIG. 3, while supplying a high pressure air to an air gun G, the air gun G sucks in sand or beads to inject the sand or beads to a bottom of a flat plate made of transparent material such as glass or PMMA (Polymethyl Metacrylate) such that concave grooves are formed in the bottom of the flat plate. These concave grooves allow the flat plate to act as the light dispersing unit 22. In addition, the concave grooves are physical concave grooves caused by mechanical collisions, so they substantially show no elapsed time change, which happened in a conventional filter made of polymer coloring matters.

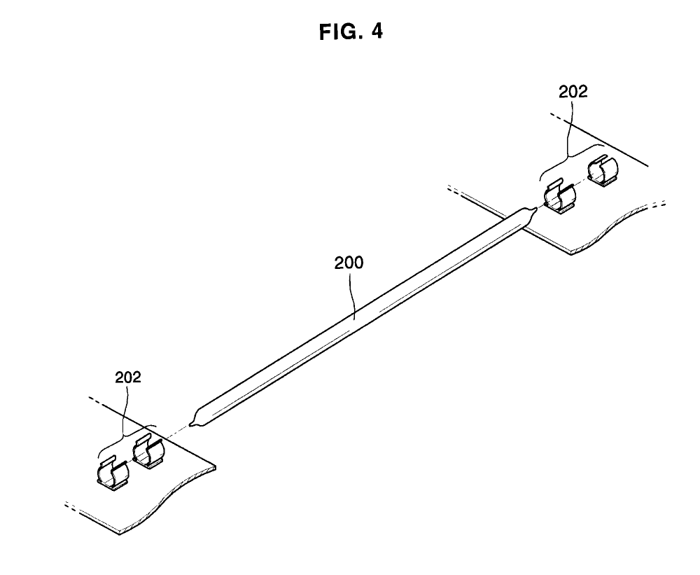

FIG. 4 shows a UV lamp used in the present invention. Referring to FIG. 4, the present invention employs a plurality of CCFLs (Cold Cathode Fluorescent Lamps) or EEFLs (External Electrode Fluorescent Lamps).

CCFL is a fluorescent lamp that lights at a low temperature without heating of a filament. The CCFL includes a glass tube and electrodes provided to both ends of the glass tube. The glass tube is filled with a mixture gas containing mercury, argon or neon. A fluorescent substance is coated on an inner surface of the glass tube. While a general fluorescent lamp initiates emission of electrons by heating, the CCFL causes emission of electrons by means of an electric field caused by a high voltage applied to both electrodes. If emission of electrons is initiated, the emitted electrons excite mercury atoms in the glass tube, thereby emitting UV rays. The emitted UV rays are collided with the fluorescent substance on the wall of the glass tube, and thus visible rays are emitted from the fluorescent substance. This CCFL is utilized as a backlight of a LCD, a light source of a facsimile, a scanner, a duplicator or a panel display, or a decorating light.

Meanwhile, the CCFL has low energy consumption, high brightness and excellent color rendering, so it is used as not only a light source of a backlight unit of TFT-LCD allowing full color but also a light source of office equipment or various displays. In addition, the CCFL has a small tube diameter, which facilitates greatly reducing a thickness of a light panel, so it is also used as a light source of an advertising light panel. This CCFL is manufactured in a way of coating a fluorescent substance on an inner surface of the glass tube, attaching electrodes to both ends of the glass tube, and then inserting inert gas and a small amount of mercury into the lamp in a sealed state. If a high voltage is applied to both ends of the lamp, electrons existing in the glass tube are attracted to the electrode rapidly, and the electrons are collided with the electron to generate secondary electrons, which initiates electric discharging. That is, the electrons emitted from the electrode are collided with mercury atoms, and this collision generates UV rays of for example 253.7 nm. These UV rays excite the fluorescent substance coated on the inner surface of the glass tube, so visible rays are emitted from the excited fluorescent substance.

EEFL has a brightness of 400 nit or above, which is more than 60% superior to the brightness of CCFL, so the EEFL is advantageous in spreading applications of TFT LCD that needs high brightness. In addition, differently from CCFL having electrodes in a lamp, the EEFL has electrodes outside. Thus, the EEFL may be easily operated in parallel and it may also realize uniform brightness by reducing voltage differences among lamps. In particular, if EEFL is adopted, the number of inverters, which was required for every lamp in the prior art, may be reduced into one, so it is possible to reduce costs and weight of a LCD module due to the decreased number of parts. In addition, it is also advantageous that the EEFL has a high energy efficiency and a long life cycle over 50,000 hours.

The UV trans-illuminator of the present invention as described above gives a high brightness with a slim design since CCFLs or EEFLs are adopted. In addition, the UV trans-illuminator has excellent uniformity and small elapsed time change since a dispersion surface having a predetermined roughness by bead blasting or sand blasting is provided.

### APPLICABILITY TO THE INDUSTRY

As explained above, the UV trans-illuminator of the present invention has a slim design, excellent uniformity and a long life cycle. In particular, the UV trans-illuminator has small elapsed time change.

1. A UV (Ultra Violet) trans-illuminator, comprising:
a UV irradiating unit composed of a plurality of CCFLs (Cold Cathode Fluorescent Lamps) or EEFLs (External Electrode Fluorescent Lamps) arranged at intervals of 1.0 cm to 3.0 cm and having a diameter of 3 mm to 8 mm so as to irradiate UV rays from an upper surface thereof; and
a light dispersing unit disposed at a distance of 1 cm to 7 cm from the upper surface of the UV irradiating unit and dispersing the UV rays irradiated from the UV irradiating unit.

2. The UV trans-illuminator according to claim 1,
wherein the light dispersing unit is disposed at a distance of 1 cm to 7 cm from the upper surface of the UV irradiating unit and composed of a predetermined transparent light transmitting member that allows passage of only a specific wavelength range among the UV rays irradiated from the UV irradiating unit, and a bottom of the transparent light transmitting member has a dispersion surface with a predetermined roughness by bead blasting or sand blasting.

3. A UV trans-illuminator comprising:
a plurality of UV irradiating fluorescent lamps provided on a frame; and
a light dispersing unit provided on top of said fluorescent lamps, said light dispersing unit having a roughness surface having a concave-groove characteristics formed by a method including one of a bead blasting and a sand blasting, wherein said light dispersing unit effectively reduces the visual effect of a certain figure corresponding to an arrangement pattern of said fluorescent lamps.

4. The UV trans-illuminator according to claim 3, wherein said plurality of fluorescent lamps are constructed with reduced diameters and proximity to each other to effectively reduce the visual effect of said certain figure corresponding to said arrangement pattern of said fluorescent lamps.
